(19) United States
(12) Patent Application Publication
(10) Pub. No.: US 2025/0251646 A1
(43) Pub. Date: Aug. 7, 2025

(54) OPTICAL APPARATUS AND IMAGING APPARATUS

(71) Applicant: CANON KABUSHIKI KAISHA, Tokyo (JP)

(72) Inventor: KATSUMI OHMORI, Tochigi (JP)

(21) Appl. No.: 19/039,073

(22) Filed: Jan. 28, 2025

(30) Foreign Application Priority Data
Feb. 1, 2024 (JP) 2024-014202

(51) Int. Cl. G03B 13/34; G03B 17/12

(52) U.S. Cl. CPC G03B 13/34; G03B 17/12; G03B 2217/007

(57) ABSTRACT

A lens apparatus comprises a second lens unit and a fourth lens unit supported so as to be movable in an optical axis direction, a vibration wave motor unit configured to drive the second lens unit, a VCM configured to drive the fourth lens unit, a fixed barrel that supports the vibration wave motor unit and the VCM, a booster transformer constituting the vibration wave motor unit, an inductor constituting the VCM, and a flexible printed circuit board on which the booster transformer and the inductor are mounted. At least one of the vibration wave motor unit and the VCM overlaps at least one of the booster transformer and the inductor when viewed from the optical axis direction.

### BACKGROUND

### Technical Field

The present disclosure relates to an optical apparatus and an imaging apparatus including the same.

### Description of the Related Art

In a lens apparatus of a digital camera, a video camera, or the like, there is known a technique of moving a plurality of lens units at the time of focus adjustment to shorten the shortest image taking distance (minimum object distance), to improve close-range image quality, or the like. As a technique of moving each of a plurality of lens units using a separate driving unit, a technique of moving a plurality of lens units by a plurality of actuators such as an ultrasonic motor and a VCM (VOICE COIL MOTOR) is known.

Japanese Patent Application Laid-Open No. 2023-130624 discloses a lens barrel having a configuration in which each of a plurality of lens units is moved using a separate driving unit.

### SUMMARY

The present disclosure features an optical apparatus comprising: a first optical element and a second optical element supported so as to be movable in an optical axis direction, a first driving unit configured to drive the first optical element, a second driving unit configured to drive the second optical element, a support member that supports the first driving unit and the second driving unit, a first circuit component constituting the first driving unit, a second circuit component constituting the second driving unit, and a circuit board on which the first circuit component and the second circuit component are mounted, wherein at least one of the first driving unit and the second driving unit overlaps at least one of the first circuit component and the second circuit component when viewed from the optical axis direction.

Further features of the present invention will become apparent from the following description of exemplary embodiments with reference to the attached drawings.

### BRIEF DESCRIPTION OF THE DRAWINGS

FIG. 1 is a cross-sectional view of a camera system (300).

FIG. 2 is a block diagram of the camera system (300).

FIG. 3 is a side view of a main portion of the lens apparatus (100).

FIG. 4 is a rear view of a main portion of the lens apparatus (100) as viewed from the image side.

FIG. 5 is a view illustrating the arrangement of members of the lens apparatus (100) as viewed from the object side.

### DESCRIPTION OF THE EMBODIMENTS

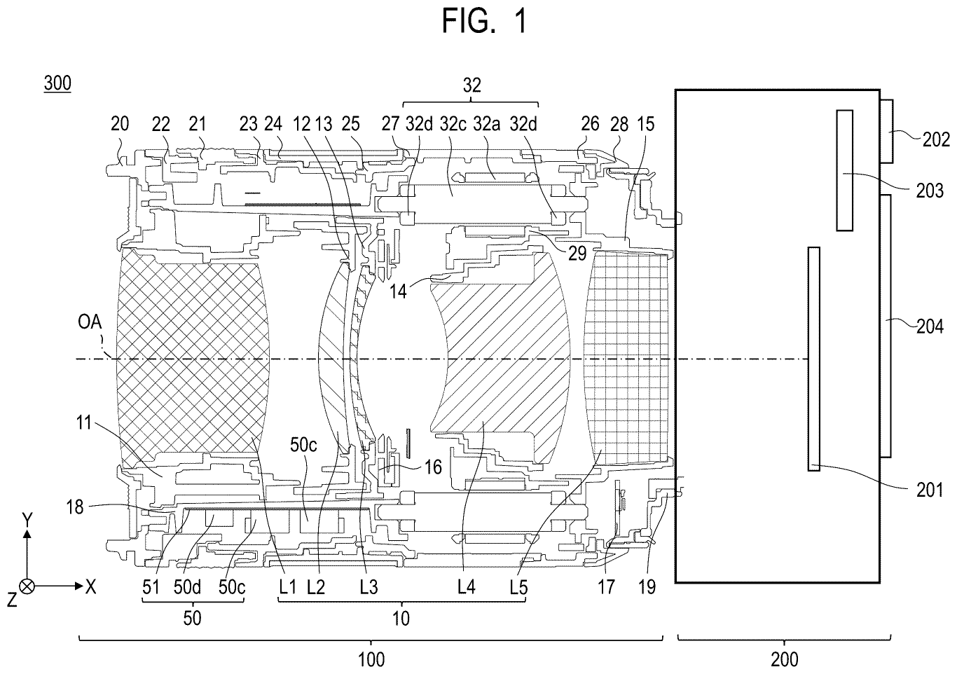

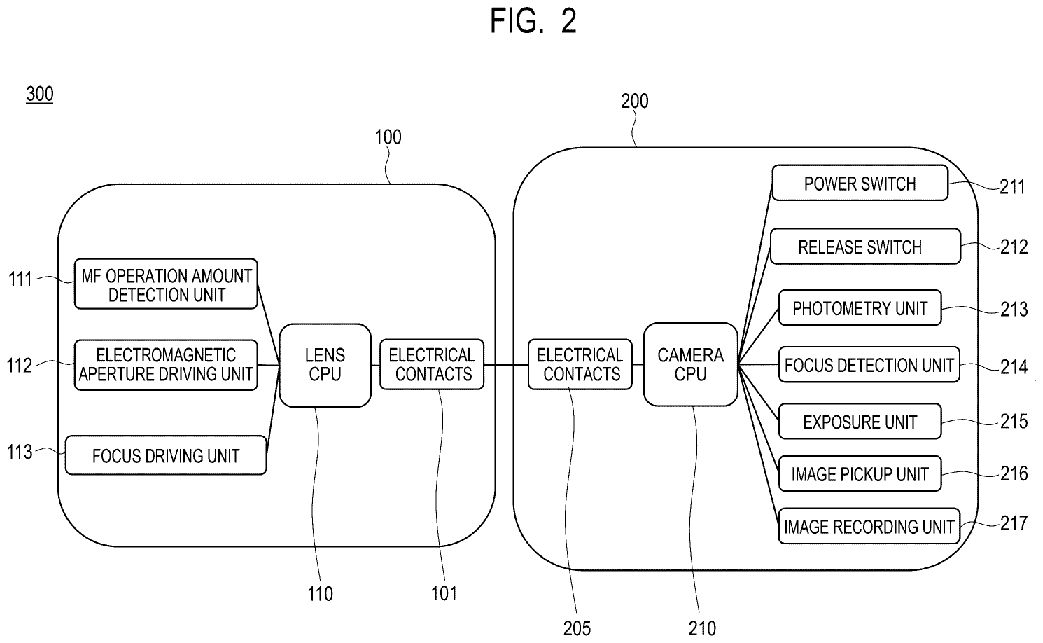

Preferred embodiments of the present invention will now be described in detail in accordance with the accompanying drawings. A camera system (imaging apparatus) 300 according to an embodiment of the present disclosure will be described with reference to FIGS. 1 and 2. FIG. 1 is a cross-sectional view of a lens apparatus 100 (optical apparatus) and a camera body 200 (image pickup apparatus main body) that constitute a camera system 300. The lens apparatus 100 is an interchangeable lens that can be attached to and detached from the camera body 200. At this time, an optical axis direction in the lens apparatus 100 is defined as an X axis, a pitch direction is defined as a Y axis, and a yaw direction is defined as a Z axis.

The camera body 200 includes an image-pickup element 201, a finder 202, a control unit 203, a display unit 204, and the like. The image-pickup element 201 includes a CCD (Charge Coupled Device) sensor or a CMOS (Complementary Metal Oxide Semiconductor) sensor and is configured to photoelectrically convert an optical image (object image) formed via an imaging optical system 10 (to be described later) to output image data. By looking into the finder 202, a captured image can be checked, and a line of sight can be input. The control unit 203 includes a camera CPU 210 and controls the operation of each unit of the camera system 300. The display unit 204 has a captured image display function and a touch panel function capable of changing various settings of the camera system 300.

The lens apparatus 100 includes an imaging optical system 10. The imaging optical system 10 includes a first lens unit L1, a second lens unit L2 (first optical element), a third lens unit L3, a fourth lens unit L4 (second optical element), and a fifth lens unit L5. The imaging optical system 10 including these lenses has an optical axis OA. The first lens unit L1, the second lens unit L2, the third lens unit L3, the fourth lens unit L4, and the fifth lens unit L5 are held by a first lens unit holding frame 11, a second lens unit holding frame 12, a third lens unit holding frame 13, a fourth lens unit holding frame 14, and a fifth lens unit holding frame 15, respectively.

Further, the imaging optical system 10 includes an electric aperture unit 16. The electric aperture unit 16 adjusts the amount of light that passes through the lens apparatus 100 and reaches the camera body 200. An aperture actuator of the electric aperture unit 16 is driven by a drive signal from an electric circuit board 17, and an aperture blade (not illustrated) is moved in an opening/closing direction, thereby changing an aperture diameter.

The lens apparatus 100 is a so-called fixed focal length lens without a magnification-varying function. The second lens unit L2 and the fourth lens unit L4 which are supported so as to be movable in the optical axis direction form a part of the imaging optical system 10, and at the time of focus adjustment (at the time of focusing), the second lens unit L2 and the fourth lens unit L4 are moved in the optical axis direction by receiving a driving force from actuators which will be described later, and focus adjustment is performed.

The first lens unit holding frame 11, the third lens unit holding frame 13, and the fifth lens unit holding frame 15 are fixed to a fixed barrel 18 (support member) by screws or the like. Further, a mount member 19 which can be attached to and detached from the camera body 200 is fixed to the fixed barrel 18 by screws, and the electric circuit board 17 is fixed.

The electric circuit board 17 is provided with an electric circuit for controlling the operation of the lens apparatus 100 and performing various calculations. Note that the fixed barrel 18 does not move during focusing. The electric aperture unit 16 is fixed to the third lens unit holding frame 13 with screws.

A filter frame 20 has a function of supporting accessories such as a hood and a filter. A control ring 21 is rotatably supported at a fixed position by support frames 22 and 23. By rotating the control ring 21, an arbitrary function assigned to the camera body 200 can be operated. A focus ring 24 is rotatably supported at a fixed position by the support frames 23 and 25. The photographer can manually adjust the focus by rotating the focus ring 24. An iris ring 26 is rotatably supported at a fixed position by an exterior ring 27 and a support frame 28. By rotating the iris ring 26, adjustment of blur and exposure can be controlled more intuitively.

FIG. 2 is a block diagram illustrating a configuration of the camera system 300 including a lens apparatus 100 and a camera body 200. The camera CPU 210 includes a microcomputer and controls operations of respective units in the camera body 200. Further, when the camera body 200 is attached to the lens apparatus 100, the camera CPU 210 communicates with a lens CPU 110 provided in the lens apparatus 100 via electrical contacts 101 and 205. Information transmitted from the camera CPU 210 to the lens CPU 110 includes driving amount information of a second lens unit L2 which is one of focus lenses. And information transmitted from the lens CPU 110 to the camera CPU 210 includes imaging magnification information and the like. The electrical contacts 101 and 205 include contacts for supplying power from the camera body 200 to the lens apparatus 100. A power switch 211 is a switch that can be operated by the photographer and is used to activate the camera CPU 210 and to start supplying power to actuators, sensors, and the like in the camera system.

First, the control of the camera body 200 will be described. A release switch 212 is a switch that can be operated by the photographer and includes a first stroke switch and a second stroke switch. A signal from the release switch 212 is input to the camera CPU 210. The camera CPU 210 enters an image-pickup preparation stage in response to input of an ON signal from the first stroke switch. In the image-pickup preparation stage, measurement of subject brightness by a photometry unit 213 and focus detection by a focus detection unit 214 are performed. And the camera CPU 210 calculates the aperture value of the electric aperture unit 16 mounted in the lens apparatus 100, the exposure amount (shutter speed) of the image-pickup element 201, and the like based on the measurement results, and determines the driving amounts of the second lens unit L2 and the fourth lens unit L4, which are focus lenses for obtaining an in-focus state with respect to the subject, based on the focus information of the imaging optical system 10 obtained by the focus detection unit 214 of the camera CPU 210. The information of the driving amount (focus lens driving amount information) is transmitted to the lens CPU 110. And the lens CPU 110 performs the operation of each component of the lens apparatus 100 is controlled.

When the ON signal is input from the second stroke switch, the camera CPU 210 transmits an aperture driving command to the lens CPU 110 and sets the electric aperture unit 16 to the calculated aperture value. Further, the camera CPU 210 transmits an exposure start command to an exposure unit 215 to open a shutter (not illustrated) and causes an image pickup unit 216 including the image-pickup element 201 to perform an exposure operation for a subject image. An image-pickup signal from the image pickup unit 216 (image-pickup element 201) is converted into a digital signal by a signal processor in the camera CPU 210, subjected to various correction processes, and output as an image signal data. The image signal data is written and stored in an image recording unit 217 in a semiconductor memory such as a flash memory or a recording medium such as a magnetic disk or an optical disk.

Next, control of the lens apparatus 100 will be described. A MF operation amount detection unit 111 detects the rotation of the focus ring 24 using a sensor (not illustrated). An electromagnetic aperture driving unit 112 brings the electric aperture unit 16 into an opening state corresponding to a designated aperture value by the lens CPU 110 that has received the aperture driving command from the camera CPU 210. A focus driving unit 113 drives the focus lens by a focus driving mechanism (to be described later) in accordance with focus driving amount information transmitted from the camera CPU 210.

Note that the camera system 300 includes the camera body 200 having the image-pickup element 201 and the lens apparatus 100 attached to and detached from the camera body 200, but the present invention is not limited thereto. The camera body 200 may be an imaging apparatus in which the camera body 200 and the lens apparatus 100 are integrally configured, or the camera body 200 may be a single-lens reflex camera having a quick return mirror.

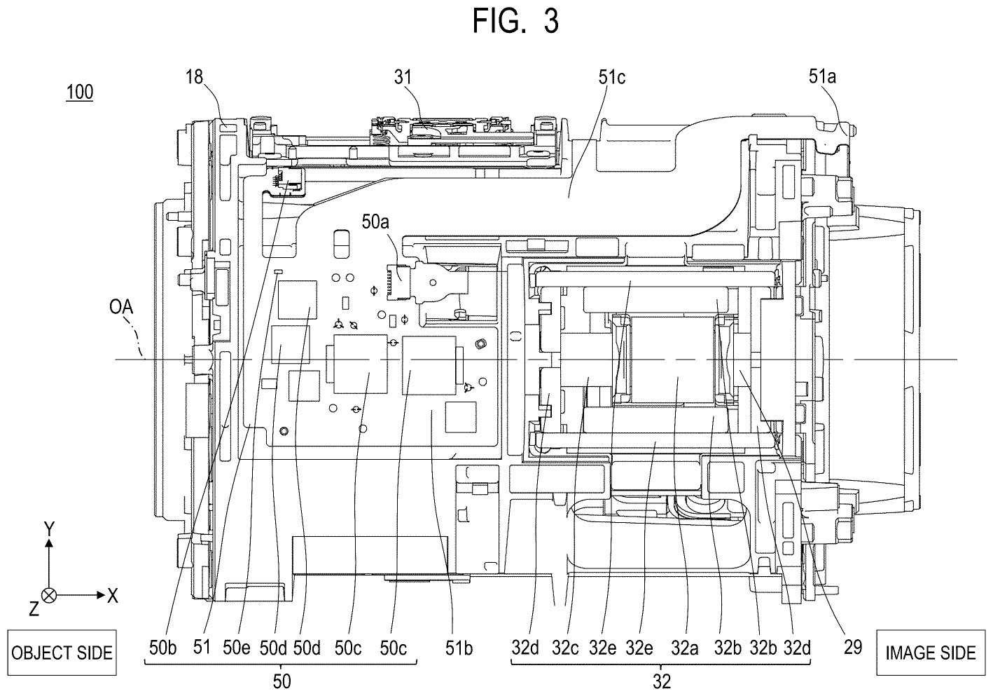

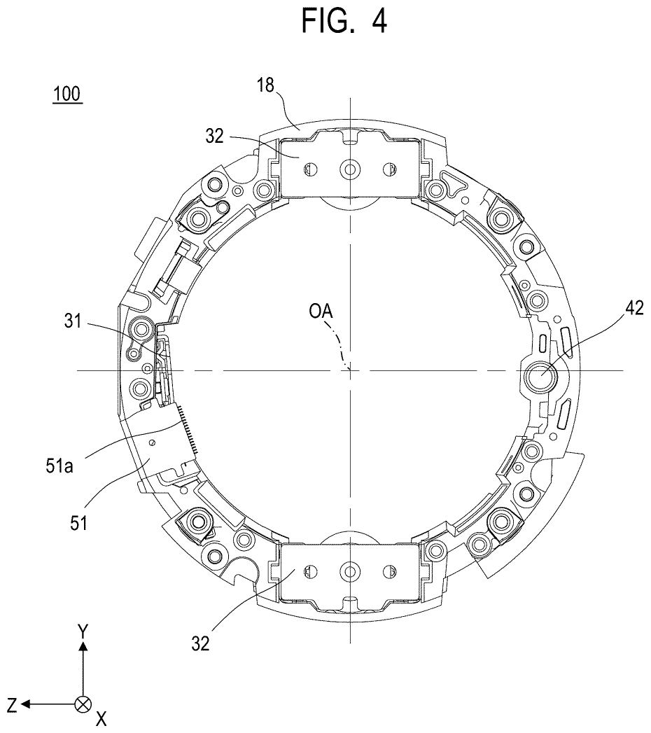

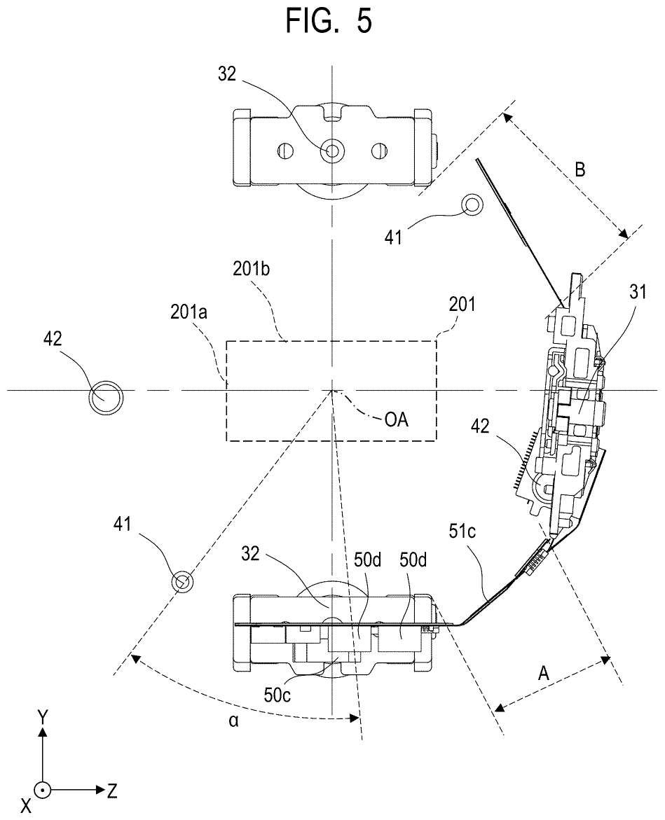

The configuration of the focus driving mechanism of the lens apparatus 100 according to the embodiment of the present disclosure will be described in detail with reference to FIGS. 1 and 3 to 5. FIG. 3 is a side view of a main portion of the lens apparatus 100, FIG. 4 is a rear view of the main portion of the lens apparatus 100 as viewed from the image side, and FIG. 5 is a view illustrating the arrangement of members of the lens apparatus 100 as viewed from the object side.

The lens apparatus 100 includes first actuator that moves the second lens unit L2 in the optical axis direction and second actuators that move the fourth lens unit L4 in the optical axis direction during focus adjustment.

The first actuator can be as a driving unit for moving the second lens unit L2 in the optical axis direction, a direct-acting vibration wave motor (hereinafter, a vibration wave motor unit 31 and first driving unit) which is a kind of an ultrasonic motor is used. A fixed portion (not illustrated) of the vibration wave motor unit 31 is fixed to the fixed barrel 18 by a screw, and the vibration wave motor unit 31 is supported by the fixed barrel 18 so that a movable element (not illustrated) of the vibration wave motor unit 31 is movable. The vibration wave motor unit 31 is connected to the second lens unit holding frame 12 via a connecting member (not illustrated). The second lens unit holding frame 12 has an engaging portion that engages with a second guide bar 41 (guide member) extending in the optical axis direction. The second guide bar 41 is held at both ends by the fixed barrel 18 and the third lens unit holding frame 13. The second lens unit holding frame 12 is supported by the second guide bar 41 so as to be able to move straight in the optical axis direction and moves in the optical axis direction in conjunction with the movement of the movable element of the vibration wave motor unit 31.

The second actuators have VCM 32 (voice coil motor, second driving unit) as a driving unit for moving the fourth lens unit L4 in the optical axis direction. At least one VCM 32 is provided, but in the embodiment, two VCMs 32 are arranged to face each other with the optical axis OA interposed therebetween. The VCM 32 is composed of a coil 32a, a magnet 32b, a pole yoke 32c, a back yoke 32d, and a side yoke 32e. The coil 32a is fixed to a fourth support frame 29 that supports the fourth lens unit holding frame 14, and the pole yoke 32c is fixed by the fixed barrel 18 and the fifth lens unit holding frame 15. That is, the VCM 32 is supported by the fixed barrel 18 such that the coil 32a, which is a movable portion of the VCM 32, is movable. The magnet 32b is attracted to and fixed to the side yoke 32e, the back yoke 32d and the side yoke 32e are attracted to and held by the attraction force of the magnet 32b, and one of the back yokes 32d arranged to face each other is fixed to the fixed barrel 18. A flexible printed circuit board (not illustrated) to which the coil 32a is soldered is attached to the fourth support frame 29. The fourth support frame 29 has a sliding portion with respect to a fourth guide bar 42 extending in the optical axis direction. The fourth guide bar 42 is held at both ends by the fixed barrel 18 and the fifth lens unit holding frame 15. When the coil 32a is energized, a force is generated that moves the fourth support frame 29 in the optical axis direction is supported by the fourth guide bar 42 so that it can move straight in the optical axis direction.

A flexible printed circuit board unit (hereinafter, a driving flexible unit 50) is fixed to the fixed barrel 18. The driving flexible unit 50 includes a flexible printed circuit board 51 (circuit board) and components mounted on the flexible printed circuit board 51. Terminals 51a of the flexible printed circuit board 51 are inserted into a connector mounted on the electric circuit board 17. The driving flexible unit 50 is mounted with connectors 50a and 50b into which terminals of the respective flexible printed circuit boards in the electric aperture unit 16 and the vibration wave motor unit 31 are inserted, and a connector (not illustrated) into which terminals of the VCM flexible printed circuit board are inserted.

Further, a booster transformer 50c (first circuit component) is also mounted on the driving flexible unit 50. The booster transformer 50c is a circuit component that outputs a voltage higher than a voltage supplied to the lens CPU 110 when the vibration wave motor unit 31 is driven and is a part of a circuit constituting a power supply of the focus driving unit 113. That is, the booster transformer 50c is a circuit component that steps up a voltage supplied from a cell or the like and applies a predetermined AC voltage to the vibration wave motor unit 31 and is a circuit component constituting a power source of the vibration wave motor unit 31.

Further, an inductor 50d (second circuit component) and a capacitor 50e are mounted on the driving flexible unit 50. These are circuit components for reducing specific components of a PWM (Pulse Width Modulation) control signal at the time of VCM 32 driving. That is, the inductor 50d is a circuit component constituting the power supply of the VCM 32. In addition, the VCM 32 is PWM-driven due to the convenience of driving by a microcomputer and the feature of low power consumption, and circuit components such as a low pass filter are included in the inductor 50d to reduce specific components of the PWM control signal. The flexible printed circuit board 51 includes terminals 51a and a wiring portion 51c connecting a mounting portion 51b on which the booster transformer 50c, the inductor 50d, the capacitor 50e, and the like are mounted, and signal lines of various actuators and the like are wired in the wiring portion 51c.

When electric power is supplied to the booster transformer 50c and the inductor 50d through the flexible printed circuit board 51, magnetic fluxes are generated in a winding axis direction of the coil provided inside. When the image-pickup element 201, which uses a solid-state image-pick up element such as CMOS, generates and outputs an image-pickup signal, the fluctuations in the magnetic fluxes may be superimposed on the image-pickup signal as magnetic noise and deteriorate the image quality. For example, if magnetic field fluctuations generated when driving the optical element of the image apparatus reach the solid-state image-pickup element and generate periodic induced electromotive forces in the readout circuit for the horizontal image signal, horizontal stripe noise may be superimposed on the image-pickup signal. Leakage magnetic flux generated from coils included in the booster transformer 50c, the inductor 50d, or the like may cause magnetic noise, and the magnetic noise may be superimposed on the image-pickup signal to deteriorate the image quality. More specifically, when the magnetic noise reaches the image-pickup element 201, a magnetic field that changes the signal line of the pixel charge information from which the image-pickup signal is extracted at a high frequency penetrates the signal line. This causes magnetism to be generated in the signal line due to electromagnetic induction, resulting in noise being generated in a signal line for pixel charge information.

Next, a positional relationship among the vibration wave motor unit 31, the VCM 32, and the driving flexible unit 50 will be described. As illustrated in FIG. 3, the vibration wave motor unit 31 is arranged closer to the object side than the VCM 32. In addition, as illustrated in FIG. 5, by arranging two VCMs 32 facing each other when viewed from the optical axis direction and the vibration wave motor unit 31 at a different phase (angle) around the optical axis direction, the lens apparatus 100 is shortened in the optical axis direction.

To reduce the influence of magnetic noise generated from the booster transformer 50c and the inductor 50d described above, the booster transformer 50c and the inductor 50d are preferably arranged on the object side as much as possible in the lens apparatus 100. Therefore, in the present embodiment, a configuration is adopted in which the booster transformer 50c and the inductor 50d are arranged closer to the object side than the VCM 32 so as to be as distant as possible from the image-pickup element 201. This makes it possible to suppress deterioration in image quality due to noise generated during movement of the lens unit.

In a state where the driving flexible unit 50 is fixed to the fixed barrel 18 if the booster transformer 50c and the inductor 50d can be laid out so as not to protrude in the radial direction from other components fixed to the fixed barrel 18, the size in the radial direction can be reduced. That is, at least one of the vibration wave motor unit 31 and the VCM 32 may be arranged so as to overlap at least one of the booster transformer 50c and the inductor 50d when viewed from the optical axis direction. In the present embodiment, the VCM 32 is arranged at a position where the booster transformer 50c and the inductor 50d overlap each other when viewed from the optical axis direction. As illustrated in FIG. 5, the booster transformer 50c and the inductor 50d are within the range of the VCM 32 when viewed in the optical axis direction. Therefore, the size of the lens apparatus 100 in the radial direction is not affected by the outer shapes of the booster transformer 50c and the inductor 50d, and the lens apparatus 100 can be downsized.

Furthermore, as illustrated in FIG. 5, the vibration wave motor unit 31 is arranged at different distances A and B in the circumferential direction with respect to the two VCMs 32 when viewed from the optical axis direction. The distance A is shorter than the distance B, and the wiring portion 51c of the flexible printed circuit board 51 passes through a side where the distance A between the vibration wave motor unit 31 and the VCM 32 in the circumferential direction is short. And the wiring portion 51c extends in the optical axis direction. This allows the length of the wiring portion 51c to be as short as possible, so that the resistances of various actuators can be reduced, power consumption can be suppressed, and noise emitted from the signal lines can be reduced.

Next, the positional relationship between the vibration wave motor unit 31 and the driving flexible unit 50 will be described. At least one of the booster transformer 50c and the inductor 50d of the driving flexible unit 50 may be arranged so as to overlap the vibration wave motor unit 31 in the optical axis direction. In the present embodiment, the vibration wave motor unit 31, the booster transformer 50c, and the inductor 50d of the driving flexible unit 50 are arranged at positions overlapping each other in the direction orthogonal to the optical axis OA. Accordingly, it is possible to reduce the length of the flexible printed circuit board 51 in the optical axis direction and to reduce the length of the lens apparatus 100 in the optical axis direction.

Further, the second guide bar 41, the booster transformer 50c, and the inductor 50d are arranged at positions overlapping each other in the optical axis direction. Further, when viewed from the optical axis direction, the second guide bar 41 is arranged at a different phase (angle a) in the circumferential direction with respect to the booster transformer 50c and the inductor 50d. Since the second guide bar 41, the booster transformer 50c, and the inductor 50d are arranged at positions overlapping each other in the optical axis direction, it is possible to reduce the size of the lens apparatus 100 in the optical axis direction, and in different phases when viewed from the optical axis direction,

Finally, the positional relationship between the image-pickup element 201 and the driving flexible unit 50 will be described. As illustrated in FIG. 5, the image-pickup element 201 has a short side 201a in the Y-axis direction and a long side 201b in the Z-axis direction when viewed from the optical axis direction and has a substantially rectangular shape in which the long side 201b is longer than the short side 201a. On the other hand, in the present embodiment, the booster transformer 50c and the inductor 50d are arranged substantially along the Y-axis, and the booster transformer 50c and the inductor 50d are arranged on the side opposed to the long side 201b of the image-pickup element 201. Accordingly, it is possible to separate the image-pickup element 201 from the booster transformer 50c and the inductor 50d when viewed from the optical axis direction, and it is possible to suppress deterioration in image quality when the lens unit moves.

According to the present embodiment, in an optical apparatus including a plurality of actuators for moving a plurality of lens units, it is possible to provide an optical apparatus and an imaging apparatus that achieve suppression of image quality deterioration due to noise from a driving unit during movement of the lens units and miniaturization of the apparatus.

Although the preferred embodiments of the present disclosure have been described above, the present disclosure is not limited to these embodiments, and various modifications and changes can be made within the scope of the gist of the present disclosure. For example, although the vibration wave motor unit 31 is used as the driving unit for moving the second lens unit L2 in the optical axis direction, two pairs of VCMs 32 may be used instead of the vibration wave motor unit 31.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-014202, filed Feb. 1, 2024, which is hereby incorporated by reference herein in its entirety.

What is claimed is:

1. An optical apparatus comprising:
a first optical element and a second optical element supported so as to be movable in an optical axis direction,
a first driving unit configured to drive the first optical element,
a second driving unit configured to drive the second optical element,
a support member that supports the first driving unit and the second driving unit,
a first circuit component constituting the first driving unit,
a second circuit component constituting the second driving unit, and
a circuit board on which the first circuit component and the second circuit component are mounted,
wherein at least one of the first driving unit and the second driving unit overlaps at least one of the first circuit component and the second circuit component when viewed from the optical axis direction.

2. The optical apparatus according to claim 1, wherein the first driving unit is located closer to the object side than the second driving unit.

3. The optical apparatus according to claim 1, wherein the first circuit component and the second circuit component are located closer to the object side than the second driving unit.

4. The optical apparatus according to claim 1, wherein the first driving unit includes a vibration wave motor unit.

5. The optical apparatus according to claim 1, comprising:
two second driving units,
wherein the second driving units are arranged to face each other with the optical axis interposed therebetween.

6. The optical apparatus according to claim 5,
wherein the first driving unit is arranged at different distances from the two second driving units in the circumferential direction, and
wherein a wiring portion of the circuit board passes through a side where a distance between the first driving unit and the second driving unit in the circumferential direction is short, and the wiring portion extends in the optical axis direction.

7. The optical apparatus according to claim 1, wherein the second driving unit includes a voice coil motor.

8. The optical apparatus according to claim 1, wherein at least one of the first circuit component and the second circuit component overlaps the first driving unit in the optical axis direction.

9. The optical apparatus according to claim 1, comprising:
a guide member that supports the first optical element so that the first optical element can move straight,
wherein the guide member is arranged at a different phase from the first circuit component and the second circuit component when viewed from the optical axis direction.

10. The optical apparatus according to claim 1, wherein the first circuit component is a booster transformer constituting a power supply of the first driving unit, and the second circuit component is an inductor constituting a power supply of the second driving unit.

11. The optical apparatus according to claim 1, wherein the optical apparatus is a fixed focal length lens without a magnification-varying function.

12. An image apparatus comprising:
an optical apparatus, and
an image-pickup element configured to photoelectrically convert an optical image formed via the optical apparatus,
the optical apparatus comprising:
a first optical element and a second optical element supported so as to be movable in an optical axis direction,
a first driving unit configured to drive the first optical element,
a second driving unit configured to drive the second optical element,
a support member that supports the first driving unit and the second driving unit,
a first circuit component constituting the first driving unit,
a second circuit component constituting the second driving unit, and
a circuit board on which the first circuit component and the second circuit component are mounted,
wherein at least one of the first driving unit and the second driving unit overlaps at least one of the first circuit component and the second circuit component when viewed from the optical axis direction,
wherein the image-pickup element has a rectangular shape having a short side and a long side, and
wherein the first circuit component and the second circuit component are arranged on a side opposed to the long side of the image-pickup element.
